(19) United States
(12) Patent Application Publication
(10) Pub. No.: US 2026/0204614 A1
(43) Pub. Date: Jul. 16, 2026

(54) LINE-TO-LINE ELECTRODE DESIGN

(71) Applicant: Medtronic, Inc., Minneapolis, MN (US)

(72) Inventors: Parthasarathy M. Gomadam, Plymouth, MN (US); Lu Yu, Remond, WA (US)

(21) Appl. No.: 19/135,178

(22) PCT Filed: Nov. 8, 2023
(86) PCT No.: PCT/IB2023/061288

§ 371 Date: Jun. 3, 2025

Related U.S. Application Data
(60) Provisional application No. 63/430,921, filed on Dec. 7, 2022.

(51) Int. Cl. H01M 10/04; H01M 4/02; H01M 4/134; H01M 10/0525; H01M 10/42; H01M 10/44

(52) U.S. Cl. CPC H01M 10/0431; H01M 10/0525; H01M 10/425; H01M 10/44; H01M 2004/021; H01M 4/134; H01M 2010/4271; H01M 2220/30

(57) ABSTRACT

Electrochemical cells and batteries are disclosed. An electrochemical cell may include a cathode electrode (122) and an anode electrode (124). The cathode electrode may include a cathode major surface and one or more cathode edges defining a perimeter of the cathode major surface. The anode electrode may include lithium, an anode major surface facing the cathode major surface, and one or more anode edges defining a perimeter of the anode major surface. The one or more anode edges may be arranged line-to-line with the one or more cathode edges.

This application claims the benefit of U.S. Provisional Patent Application Ser. No. 63/430,921, filed 7 Dec. 2022, the entire content of which is incorporated herein by reference.

### FIELD

The present disclosure relates to, among other things, batteries or electrochemical cells.

### TECHNICAL BACKGROUND

Lithium-ion batteries or electrochemical cells are typically designed to have an anode that is wider and/or taller than the cathode. In other words, the anode of lithium-ion batteries typically overhangs the edges of the cathode. Such overhang of the anode relative to the cathode may reduce or prevent conditions that result in lithium plating when lithium-ion batteries are charged. However, battery designs where the anode overhangs the cathode may reduce the energy density of such batteries. Additionally, the percentage reduction in energy density that results from anode overhang may increase as the size of lithium-ion batteries decreases.

### BRIEF SUMMARY

The present disclosure describes, among other things, lithium batteries or electrochemical cells with a relatively high energy density using a line-to-line electrode design. Additionally, lithium plating in batteries or cells with a line-to-line electrode design may be reduced or prevented by limiting a charging current of the batteries. Batteries and cells may include a cathode electrode and an anode electrode. The anode electrode may include lithium. The sizes and arrangement of the cathode electrode and the anode electrode may be such that edges of the cathode electrode and the anode electrode may be aligned. Accordingly, the batteries and cells described herein can maintain relatively high energy densities even when the batteries are relatively small because the battery does not include excess anode electrode surface area relative to the cathode electrode. Additionally, such increased energy densities of the batteries may be achieved without a corresponding increase in lithium plating during charging.

Described herein, among other things, is an electrochemical cell comprising a cathode electrode and an anode electrode. The cathode electrode may comprise a cathode major surface and one or more cathode edges defining a perimeter of the cathode major surface. The anode electrode may comprise lithium, an anode major surface facing the cathode major surface, and one or more anode edges defining a perimeter of the anode major surface. The one or more anode edges may be arranged line-to-line with the one or more cathode edges.

In general, in one aspect, the present disclosure describes a system comprising a battery and a battery management system. The battery may comprise a cathode electrode and an anode electrode. The anode electrode may comprise lithium. The anode electrode may be arranged line-to-line with the cathode electrode. The battery management system may be operatively coupled to the battery and configured to limit a charging rate of the battery to a threshold rate of no greater than C/5.

In general, in one aspect, the present disclosure describes an implantable medical device comprising a housing, a battery, and a controller. a battery disposed in the housing, the battery may comprise a cathode electrode and an anode electrode. The anode electrode may comprise lithium. The anode electrode may be arranged line-to-line with the cathode electrode. The controller may be disposed in the housing and may be operatively coupled to the battery.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is a perspective view of an example electrode stack that includes an oversized anode electrode;

FIG. 2 is a perspective view of an embodiment of an electrode stack that includes electrodes arranged line-to-line;

FIG. 3 is an exploded perspective view of the electrode stack of FIG. 2;

FIG. 4 is a cross-sectional side view of another embodiment of an electrode stack that includes electrodes arranged line-to-line;

FIG. 5 is a cross-sectional side view of yet another embodiment of an electrode stack that includes electrodes arranged line-to-line; and

FIG. 6 is a schematic diagram of a battery or electrochemical cell that includes an electrode stack with electrodes arranged line-to-line;

FIG. 7 is a schematic block diagram of a system that includes the battery of FIG. 6;

FIG. 8 is a conceptual drawing illustrating an embodiment of an implantable medical device that includes the battery of FIG. 6.

The schematic drawing is not necessarily to scale.

### DETAILED DESCRIPTION

Reference will now be made in greater detail to various embodiments of the subject matter of the present disclosure, one or more embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

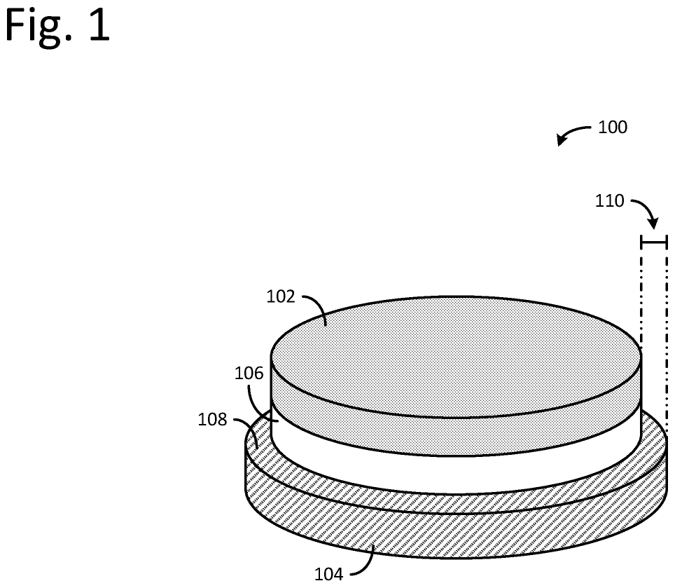

Lithium batteries or electrochemical cells can generally provide higher energy density in a lighter package than other battery types. However, lithium batteries may be susceptible to lithium plating under certain conditions. Such lithium plating can, for example, create conductive bridges that may lead to shorts within lithium batteries, increase an internal resistance of the battery, cause deformation of the battery, etc. Under typical charging conditions, when a cathode electrode overhangs or extends past an edge of an anode electrode in a battery, undesirable lithium plating may occur. One way to reduce the occurrence of such lithium plating is to design lithium batteries with an oversized anode electrode that extends past edges of the cathode electrode. An example electrode stack 100 that includes an oversized anode electrode is depicted in FIG. 1.

The electrode stack 100 includes a cathode electrode 102, an anode electrode 104, and a separator 106 disposed between the cathode electrode 102 and the anode electrode 104. As shown, the anode electrode 104 is oversized such that the anode electrode 104 includes an overhang 108 that extends past edges of the cathode electrode. The overhang 108 of the anode electrode 104 may have a width 110 of up to 1 millimeter. In other words, the anode electrode 104 can extend past edges of the cathode electrode 102 by as much as 1 millimeter. While oversized anode electrodes such as the anode electrode 104 may reduce or prevent undesirable lithium plating, the overhang 108 of the anode electrode 104 may not participate in battery intercalation. Consequently, the overhang 108 of the anode electrode 104 may contribute to the overall size and volume of a battery but may not contribute to the usable energy capacity of the battery. Accordingly, the use of oversized anode electrodes in batteries (e.g., the anode electrode 104) may reduce lithium plating during charging but may also result in batteries with a lower energy density. However, lithium plating during charging can be reduced using batteries or electrochemical cells with line-to-line electrode arrangements that have increased energy density relative to batteries that include oversized anode electrodes (e.g., the anode electrode 104) that include an overhang (e.g., the overhang 108) caused by the oversized anode electrodes in excess of manufacturing tolerances.

Analysis using mechanistic multi-dimensional modeling has revealed several factors that may contribute to conditions that cause lithium plating in lithium batteries or electrochemical cells. Of such factors, it was found that the charging current can play a significant role in the conditions that cause lithium plating. The multi-dimensional model was further used to analyze lithium plating conditions for a range of charging rates, electrode overhang widths, and other battery parameters. It was found that low charging rates of lithium-ion batteries may prevent conditions that result in lithium plating from occurring. For example, charging a typical lithium-ion battery at a 0.2 C or C/5 rate (e.g., a charging rate that charges a full capacity of the battery in 5 hours) may prevent conditions that result in lithium plating from occurring in such typical lithium-ion batteries. However, charging rates that prevent lithium plating may depend on the specifics of the actual battery parameters. Accordingly, undesirable lithium plating may be prevented or reduced in batteries that include line-to-line electrode arrangements without relying on oversized anode electrodes that include an overhang (e.g., the anode electrode 104) caused by the oversized anode electrodes in excess of manufacturing tolerances.

As used herein, the term “line-to-line” may refer to a relationship between two elements such that edges or perimeters of corresponding surfaces of the two elements are substantially aligned. In other words, when two elements are arranged line-to-line with each other, one of the two elements may not overhang the other of the two elements by more than a threshold tolerance. In general, during fabrication or manufacture of devices and apparatus, the physical characteristics (e.g., height, width, position, etc.) of such devices and apparatus are subject to variation within a tolerance. Accordingly, a width of any overhang between two elements arranged line-to-line may be no greater than a threshold tolerance. The threshold tolerance of an overhang width between two elements arranged line-to-line may be, for example, 0.5 millimeters or less, 0.4 millimeters or less, 0.3 millimeters or less, 0.2 millimeters or less, or 0.1 millimeters or less.

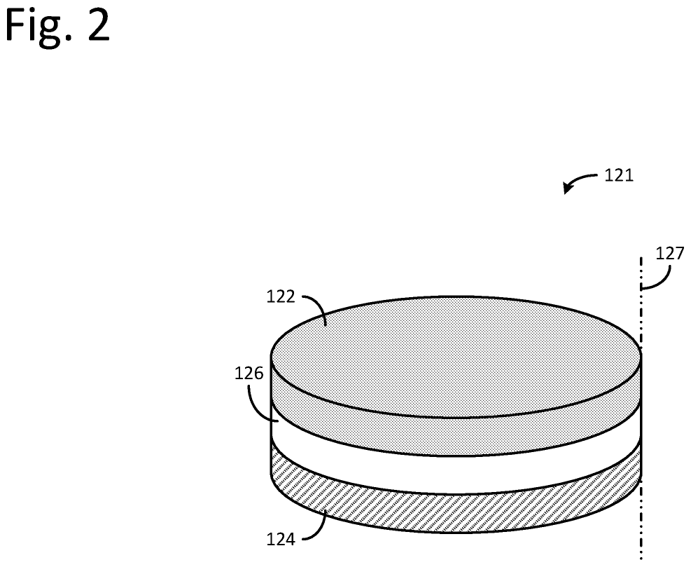

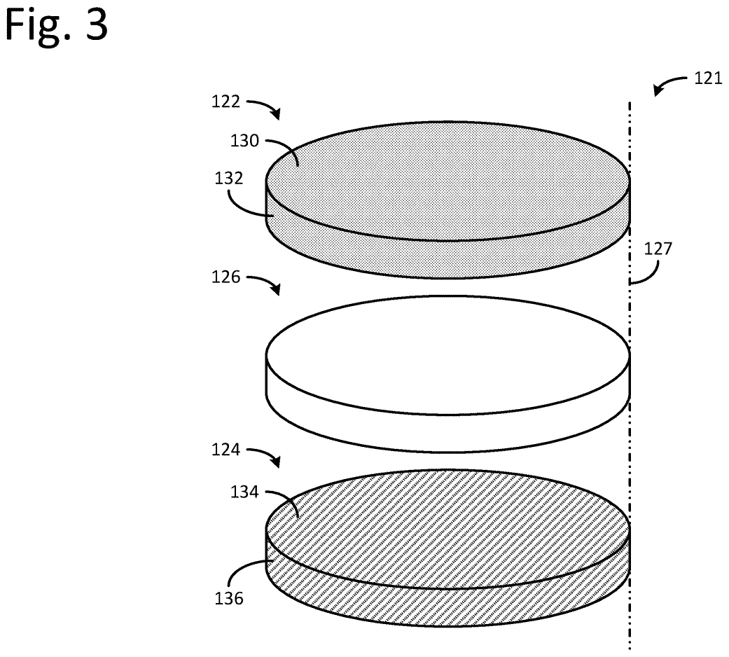

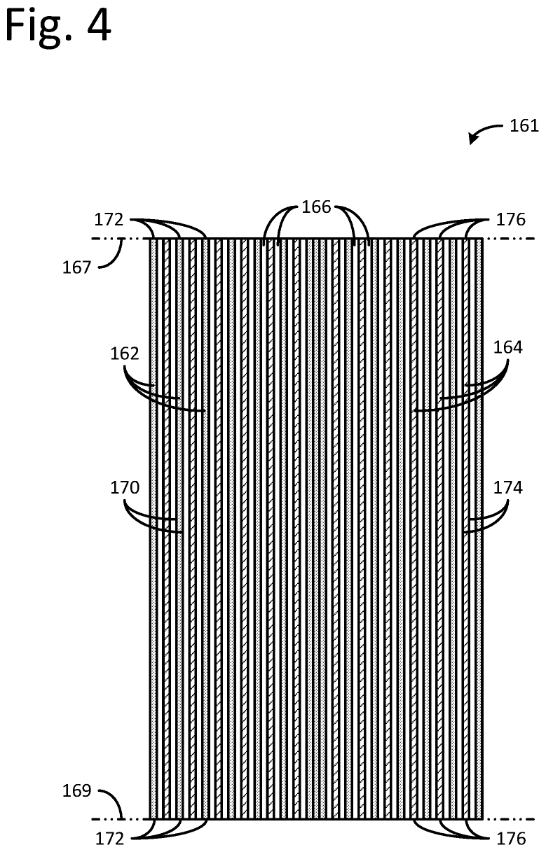

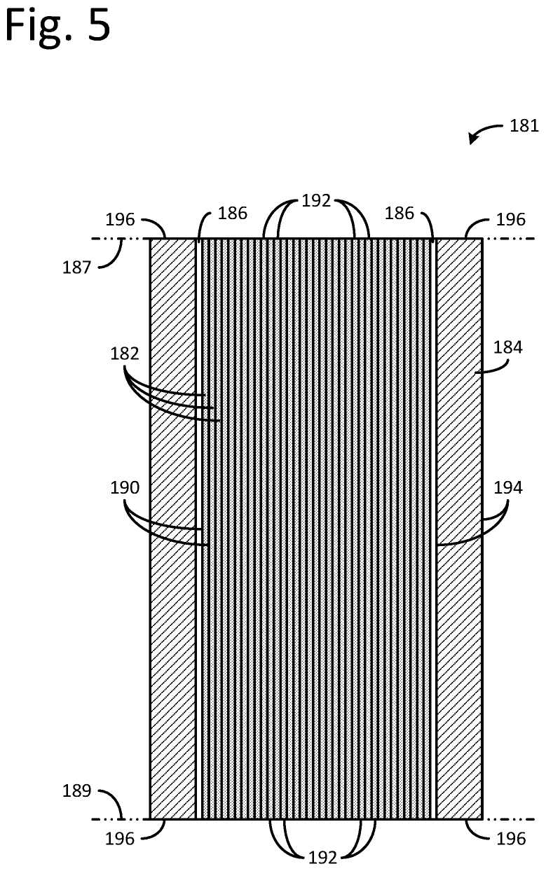

Embodiments of electrode stacks that include electrodes arranged line-to-line are depicted in FIGS. 2-5. FIG. 2 shows a perspective view of an electrode stack 121 that includes stacked plate electrodes arranged line-to-line and FIG. 3 shows an exploded perspective view of the electrode stack 121. FIG. 4 shows a cross-sectional side view of another electrode stack 161 that includes coiled electrodes arranged line-to-line. FIG. 5 shows a cross-sectional side view of yet another electrode stack 181 that includes one cylindrical electrode and one coiled electrode arranged line-to-line.

The electrode stack 121 may include a cathode electrode 122, an anode electrode 124, and a separator 126. The cathode electrode 122 may include cathode major surfaces 130 and one or more cathode edges 132 defining a perimeter of the cathode major surfaces 130. Similarly, the anode electrode 124 may include anode major surfaces 134 and one or more edges defining a perimeter of the cathode major surfaces 130. As shown, the electrode stack 121 may be a stacked plate electrode arrangement. In other words, the cathode electrode 122 and the anode electrode 124 define flat sheets with the cathode major surfaces 130 and the anode major surfaces 134 may be arranged parallel to one another. In general, at least one of the anode major surfaces 134 may face one of the cathode major surfaces 130. Furthermore, the one or more anode edges 136 may be arranged line-to-line with the one or more cathode edges 132. In other words, a line 127 that is orthogonal to the anode major surfaces 134 and coextensive with the one or more anode edges 136 may also be orthogonal to the cathode major surfaces 130 and coextensive with the one or more cathode edges 132. While manufacturing tolerances may result in a slight overhang of one or both of the cathode electrode 122 and the anode electrode 124, any overhang of the cathode electrode 122 and the anode electrode 124 may have a maximum width of less than 0.5 millimeters or less, 0.4 millimeters or less, 0.3 millimeters or less, 0.2 millimeters or less, or 0.1 millimeters or less.

Although the cathode electrode 122 and the anode electrode 124 are shown as elliptically shaped plates, the cathode electrode 122 and the anode electrode 124 can take on any suitable shape. In general, the shape of plate electrodes such as the cathode electrode 122 and the anode electrode 124 may be defined by the shape of their major surfaces. The cathode major surfaces 130 and the anode major surfaces 134 may take on any suitable two-dimensional shape such as, for example, an ellipse, a polygon, a shape with multiple curved sides (e.g., a circular triangle), a shape with curved and straight sides (e.g., a circular segment, a circular sector, a stadium, etc.), etc. In general, the cathode major surfaces 130 and the anode major surfaces 134 may be substantially the same shape and have substantially the same dimensions to allow the cathode edges 132 and the anode edges 136 to be arranged line-to-line. Furthermore, while electrode stack 121 is shown as a stacked plate arrangement, electrode stacks with line-to-line electrodes can be any suitable electrode arrangement. For example, electrode stacks that include line-to-line electrodes may include, a coiled electrode arrangement as shown in FIG. 4, a cylindrical and coiled electrode arrangement as shown in FIG. 5, or any other electrode arrangement where edges of the electrode are aligned.

As shown in FIG. 4, the electrode stack 161 includes a cathode electrode 162, an anode electrode 164, and a separator 166. Each of the cathode electrode 162 and the anode electrode 164 may be wound in a spiral shape to define a plurality of windings. The cathode electrode 162 may include cathode major surfaces 170 and one or more cathode edges 172 defining a perimeter of each of the cathode major surfaces 170. Similarly, the anode electrode 164 may include anode major surfaces 174 and one or more edges defining a perimeter of each of the cathode major surfaces 170. The one or more anode edges 176 may be arranged line-to-line with the one or more cathode edges 172. In other words, upper edges of the one or more cathode edges 172 and the one or more anode edge 176 may be coextensive with a plane 167 that is orthogonal to the cathode major surfaces 170 and the anode major surfaces 174. Additionally, lower edges of the one or more cathode edges 172 and the one or more anode edge 176 may be coextensive with a plane 169 that is orthogonal to the cathode major surfaces 170 and the anode major surfaces 174. While manufacturing tolerances may result in a slight overhang of one or both of the cathode electrode 162 and the anode electrode 164, any overhang of the cathode electrode 162 and the anode electrode 164 may have a maximum width of less than 0.5 millimeters or less, 0.4 millimeters or less, 0.3 millimeters or less, 0.2 millimeters or less, or 0.1 millimeters or less.

As shown in FIG. 5, the electrode stack 181 includes a cathode electrode 182, an anode electrode 184, and a separator 186. The cathode electrode 182 may be wound in a spiral shape to define a plurality of windings and the anode electrode 184 may define a hollow cylinder surrounding the cathode electrode 182. The cathode electrode 182 may include cathode major surfaces 190 and one or more cathode edges 192 defining a perimeter of each of the cathode major surfaces 190. Similarly, the anode electrode 184 may include anode major surfaces 194 and one or more edges defining a perimeter of each of the cathode major surfaces 190. The one or more anode edges 196 may be arranged line-to-line with the one or more cathode edges 192. In other words, upper edges of the one or more cathode edges 192 and the one or more anode edge 196 may be coextensive with a plane 187 that is orthogonal to the cathode major surfaces 190 and the anode major surfaces 194. Additionally, lower edges of the one or more cathode edges 192 and the one or more anode edge 196 may be coextensive with a plane 189 that is orthogonal to the cathode major surfaces 190 and the anode major surfaces 194. While manufacturing tolerances may result in a slight overhang of one or both of the cathode electrode 182 and the anode electrode 184, any overhang of the cathode electrode 182 and the anode electrode 184 may have a maximum width of less than 0.5 millimeters or less, 0.4 millimeters or less, 0.3 millimeters or less, 0.2 millimeters or less, or 0.1 millimeters or less.

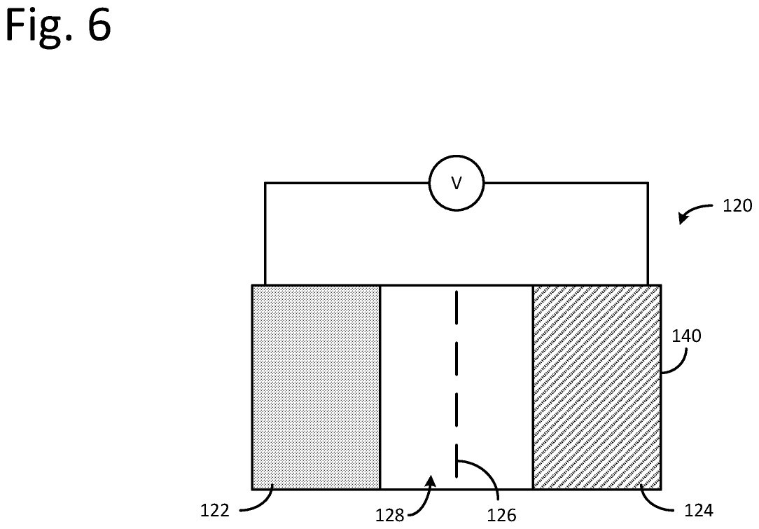

A schematic representation of an embodiment of a battery or electrochemical cell 120 is depicted in FIG. 6. Although described in regard to the electrode stack 121 of FIGS. 2 and 3, the battery 120 may include any suitable electrode stack (e.g., the electrode stack 161 of FIG. 4 or the electrode stack 181 of FIG. 5) or other line-to-line electrode arrangement. The battery 120 may be, or may form a single cell of, a rechargeable lithium battery.

The battery 120 may include a cathode electrode 122, an anode electrode 124, a separator 126, and an electrolyte 128. The battery 120 may also include a battery housing 140 that defines the exterior of the battery 120. In other words, each of the cathode electrode 122, the anode electrode 124, the separator 126, and the electrolyte 128 may be disposed in the battery housing 140. The cathode electrode 122 and the anode electrode 124 may be provided as relatively flat or planar plates, wrapped or wound in a spiral or other configuration (e.g., an oval configuration), or as a folded configuration. Regardless of the particular configuration, the cathode electrode 122 and the anode electrode 124 are arranged line-to-line with one another. The separator 126 (e.g., a polymeric microporous separator) may be arranged between the anode electrode 124 and the cathode electrode 122 to prevent direct contact between the anode electrode 124 and the cathode electrode 122.

The electrodes of the battery 120 may include any suitable material or materials. The cathode electrode 122 may include, for example, lithium-metal oxides (e.g., LiCoO2, LiMn2O4, Li(NixMnyCoz)O2, etc.), vanadium oxides, olivines (e.g., LiFePO4), sulfides, etc. In one or more embodiments, the cathode electrode 122 may include a mixture of cathode materials, such as a mixture comprising CFx with either Ag₂V₄O₁₁ or MnO₂. The anode electrode 124 may include lithium. The anode electrode 124 may also include one or more of magnesium, silver, zinc, aluminum, tin, silicon, or other elements that are soluble in lithium at a level of at least 1 weight percent.

During charging and discharging of the battery 120, lithium ions may move between the cathode electrode 122 and the anode electrode 124. Such movement of lithium ions between the cathode electrode 122 and the anode electrode 124 may be referred to as ion transfer. For example, when the battery 120 is discharged, lithium ions flow from the anode electrode 124 to the cathode electrode 122. In contrast, when the battery 120 is charged, lithium ions flow from the cathode electrode 122 to the anode electrode 124. While the separator 126 may prevent direct contact between the cathode electrode 122 and the anode electrode 124, the separator may permit the flow of ions between the anode electrode 124 and the cathode electrode 122. Furthermore, the electrolyte 128 may facilitate transport of ions between the anode electrode 124 and the cathode electrode 122.

The electrolyte 128 may be disposed in the battery housing 140. The electrolyte 128 may generally fill at least a portion of any space inside the battery housing 140 that is not filled by the other components (e.g., the cathode electrode 122, the anode electrode 124, the separator 126, insulators, conductors, etc.) of the battery 120. The electrolyte 128 may have an electrical potential. When the cathode electrode 122 and the anode electrode 124 are electrically isolated from the battery housing 140, the battery housing 140 may float at the electrical potential of the electrolyte. The electrolyte 128 may be one or more of, for example, a liquid, a gel, a paste, etc. The electrolyte 128 may include, for example, lithium salt, sulfuric acid, fluorinated sulfone, or other suitable electrolyte.

The battery 120 may have a greater energy density than typical lithium batteries that include oversized anode electrodes because the battery 120 includes electrodes in a line-to-line arrangement. A greater percentage of anode electrodes of batteries with a line-to-line electrode may contribute to energy capacity of such batteries when compared to batteries that include oversized anode electrodes. Oversized anode electrodes may include significantly larger overhangs than line-to-line electrode arrangements that do not contribute to energy density. Accordingly, more of the volume of batteries that include line-to-line electrode arrangements contribute to energy density compared to typical lithium-ion batteries that include oversized electrodes. Additionally, the difference in energy density may become more pronounced as the size or overall volume of batteries is reduced and any overhang of the anode electrode occupies a greater percentage of the overall volume. Furthermore, to facilitate a reduction or elimination or undesirable lithium plating during charging of the battery 120, a charging current of the battery 120 may be limited by any suitable device or apparatus. For example, the charging current of the battery 120 may be limited by a battery management system, a device that includes the battery 120, a charging apparatus, or other device or apparatus configured to control charging of the battery 120.

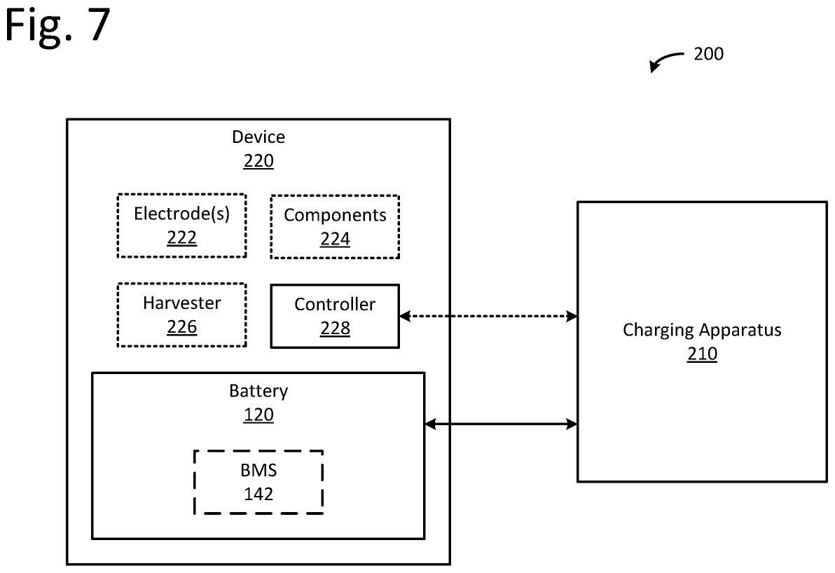

A schematic diagram of an embodiment of a system 200 including the battery 120 and a battery management system 142 is depicted in FIG. 7. The battery management system 142 may be operatively coupled to the battery 120 and configured to limit a charging rate of the battery 120 to a threshold rate no greater than C/5. Accordingly, the battery management system 142 may facilitate reduction or elimination of undesirable lithium plating during charging of the battery 120. The battery management system 142 may include one or more switches, sensors, controllers, or other apparatus to maintain safe operating conditions of the battery 120 and limit the charging current of the battery 120. The battery management system 142 may be incorporated into or otherwise included in the battery 120 (e.g., within the battery housing 140). Alternatively, the battery management system 142 may be external to the battery 120.

The battery management system 142 may be operatively couplable to external devices to provide power, receive a charging current, provide battery parameters or conditions, receive commands, receive device power requirements, etc. In one or more embodiments, the battery management system 142 may be configured to provide an indication of the threshold current to an external device. The external device may include, for example, a charging apparatus, an implantable medical device, a computing apparatus, or other device. Provision of the threshold current to the external device may allow the external device to provide a charging current that is no greater than the threshold current.

The system 200 may further include a charging apparatus 210 operatively couplable to the battery 120. Additionally, the charging apparatus 210 may be operatively couplable to the battery management system 142. The charging apparatus 210 may be configured to charge the battery 120 using a charging current less than or equal to the threshold charging current. The charging apparatus 210 may be configured to provide the charging current directly to the battery 120 or the charging apparatus 210 may be configured to provide the charging current via the battery management system 142. Furthermore, the charging apparatus 210 may be configured to provide the charging current via a wired or wireless connection. In one or more embodiments, the charging apparatus 210 may be configured to determine the threshold current. To determine the threshold current, the indication of the threshold current may be received by the charging apparatus 210 prior to charging the battery 120.

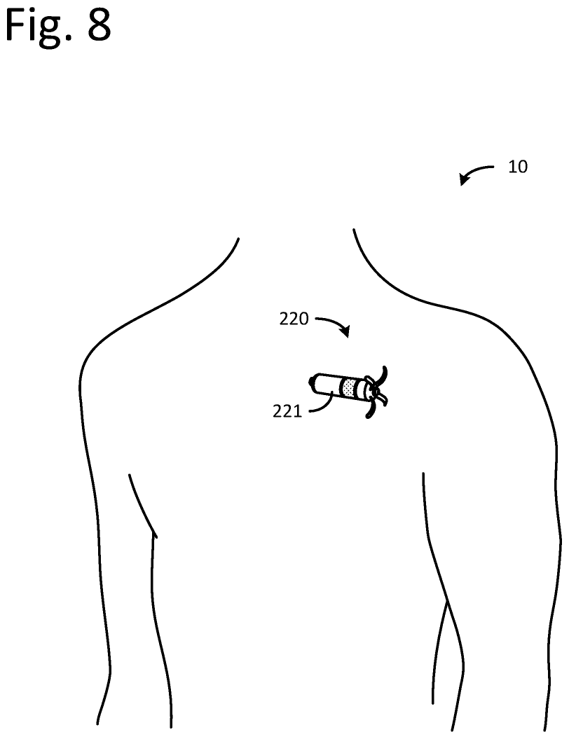

The system 200 may further include a device 220 that is powered by the battery 120. In other words, the device 220 may include the battery 120. An embodiment of the device 220 as an implantable medical device is depicted in FIG. 8. FIG. 8 shows a conceptual drawing illustrating the device 220 in conjunction with a patient 10. As depicted in FIG. 8, the device 220 includes a housing 221 that defines the exterior of an implantable medical device. The device 220 may be or may be included in, any suitable implantable medical device such as, for example, implantable pulse generators, implantable cardioverter defibrillators, implantable cardiac contractility modulators, implantable neurostimulators, implantable mechanical assist devices, etc.

The device 220 may include a controller 228 disposed in the housing 221 and operatively coupled to the battery. The controller 228 may include one or more processors, logic gates, or other digital circuitry to control operations of the device 220. The controller 228 may also include data storage for data storage and access to processing programs or routines that may be employed to carry out the techniques, processes, and algorithms of the device 220. In one or more embodiments, the controller 228 may be configured to limit a charging current of the battery to no greater than C/5. For example, the controller 228 may be operatively couplable to the charging apparatus 210 and configured to limit the charging current provided by the charging apparatus 210. In one or more embodiments, the controller 228, may be operatively coupled to an energy harvester and configured to limit a charging current delivered to the battery 120 from the energy harvester.

The device 220 may include a kinetic energy harvester 226 disposed in the housing 221 and operatively coupled to the battery 120 to charge the battery 120. The kinetic energy harvester 226 may be configured to move within the housing 221 to generate electrical energy. In other words, the kinetic energy harvester 226 may be a transducer configured to convert kinetic energy into electrical energy and provide an electric current. The controller 228 may be operatively coupled to the kinetic energy harvester 226 and configured to receive the electrical energy provided by the kinetic energy harvester and use such electrical energy to charge the battery 120.

The device 220 may also include one or more one or more electrodes 222 to facilitate delivery of the therapeutic electrical pulses to desired treatment areas. The device 220 may include the one or more electrodes with or without leads. The device 220 may also include one or more electrical components 224 disposed in the housing 221. The one or more electrical components 224 may include one or more pulse generators, switches, passive electrical components (e.g., capacitors, inductors, or resistors), digital logic circuits, processors, or other components to facilitate operation of the device 220. Additionally, the one or more electrical components 224 may be operatively coupled to the battery 120 to receive power. In other words, the battery 120 may be configured to provide power to the one or more electrical components.

The invention is defined in the claims. However, below there is provided a non-exhaustive list of non-limiting examples. Any one or more of the features of these examples may be combined with any one or more features of another example, embodiment, or aspect described herein.

Example Ex1: An electrochemical cell comprising: a cathode electrode comprising: a cathode major surface; and one or more cathode edges defining a perimeter of the cathode major surface; and an anode electrode comprising: lithium; an anode major surface facing the cathode major surface; and one or more anode edges defining a perimeter of the anode major surface, the one or more anode edges arranged line-to-line with the one or more cathode edges.

Example Ex2: The electrochemical cell as in example Ex1, wherein a height of the anode electrode is equal to or less than a height of the cathode electrode.

Example Ex3: The electrochemical cell as in any one of the previous examples, wherein a width of the anode electrode is equal to or less than a width of the cathode electrode.

Example Ex4: The electrochemical cell as any one of the previous examples, wherein the anode major surface comprises an overhang portion relative to the cathode major surface of no greater than 0.5 millimeters.

Example Ex5: The electrochemical cell as in any one of the previous examples, wherein the anode electrode defines a plurality of windings.

Example Ex6: The electrochemical cell as in any one of examples Ex1 to Ex4, wherein the anode electrode defines a hollow cylinder.

Example Ex7: The electrochemical cell as in any one of the previous examples, further comprising a separator disposed between the cathode electrode and the anode electrode.

Example Ex8: The electrochemical cell as in any one of the previous examples, further comprising: a housing defining an exterior surface of the electrochemical cell; and an electrolyte disposed in the housing.

Example Ex9: A system comprising: a battery comprising: a cathode electrode; and an anode electrode comprising lithium and arranged line-to-line with the cathode electrode; and a battery management system operatively coupled to the battery and configured to limit a charging current of the battery to a threshold charging rate of C/5.

Example Ex10: The system as in example Ex9, wherein the battery management system is further configured to provide an indication of the threshold current to an external device.

Example Ex11: The system as in any one of examples Ex9 or Ex10, further comprising a charging apparatus operatively couplable to the battery management system and configured to charge the battery at a charging current less than or equal to the threshold charging current.

Example Ex12: The system as in any one of examples Ex9 to Ex11, further comprising a charging apparatus operatively couplable to the battery management system and configured to: determine the threshold charging current; and charge the battery using a charging current less than or equal to the threshold charging current.

Example Ex13: The system as in any one of examples Ex9 to Ex12, wherein a height of the anode electrode is equal to or less than a height of the cathode electrode.

Example Ex14: The system as in any one of examples Ex9 to Ex13, wherein a width of the anode electrode is equal to or less than a width of the cathode electrode.

Example Ex15: The system as in any one of examples Ex9 to Ex14, wherein: the cathode electrode comprises: a cathode major surface; and one or more cathode edges defining a perimeter of the cathode major surface; and wherein the anode electrode further comprises: an anode major surface facing the cathode major surface; and one or more anode edges defining a perimeter of the anode major surface, the one or more anode edges arranged line-to-line with the one or more cathode edges.

Example Ex16: The system as in any one of examples Ex9 to Ex15, wherein the anode major surface comprises an overhang portion relative to the cathode major surface of no greater than 0.5 millimeters.

Example Ex17: The system as in any one of examples Ex9 to Ex16, wherein the anode electrode defines a plurality of windings.

Example Ex18: The system as in any one of examples Ex9 to Ex16, wherein the anode electrode defines a hollow cylinder.

Example Ex19: The system as in any one of examples Ex9 to Ex18, further comprising a separator disposed between the cathode electrode and the anode electrode.

Example Ex20: The system as in any one of examples Ex9 to Ex19, further comprising: a housing defining an exterior surface of the battery; and an electrolyte disposed in the housing.

Example Ex21: An implantable medical device comprising: a housing; a battery disposed in the housing, the battery comprising: a cathode electrode; and an anode electrode comprising lithium and arranged line-to-line with the cathode electrode; and a controller disposed in the housing and operatively coupled to the battery.

Example Ex22: The device as in example Ex21, wherein the controller is configured to limit a charging rate of the battery to no greater than C/5.

Example Ex23: The device as in any one of examples Ex21 or Ex22, further comprising a kinetic energy harvester disposed in the housing and operatively coupled to the battery to charge the battery.

Example Ex24: The device as in any one of examples Ex21 to Ex23, further comprising one or more electrodes to deliver therapeutic electrical pulses to a patient.

Example Ex25: The device as in any one of examples Ex21 to Ex24, wherein a height of the anode electrode is equal to or less than a height of the cathode electrode.

Example Ex26: The device as in any one of examples Ex21 to Ex25, wherein a width of the anode electrode is equal to or less than a width of the cathode electrode.

Example Ex27: The device as in any one of examples Ex21 to Ex26, wherein: the cathode electrode comprises: a cathode major surface; and one or more cathode edges defining a perimeter of the cathode major surface; and wherein the anode electrode further comprises: an anode major surface facing the cathode major surface; and one or more anode edges defining a perimeter of the anode major surface, the one or more anode edges arranged line-to-line with the one or more cathode edges.

Example Ex28: The device as in example Ex27, wherein the anode major surface comprises an overhang portion relative to the cathode major surface of no greater than 0.5 millimeters.

Example Ex29: The device as in any one of examples Ex21 to Ex28, wherein the anode electrode defines a plurality of windings.

Example Ex30: The device as in any one of examples Ex21 to Ex28, wherein the anode electrode defines a hollow cylinder.

Example Ex31: The device as in any one of examples Ex21 to Ex30, further comprising a separator disposed between the cathode electrode and the anode electrode.

Example Ex32: The device as in any one of examples Ex21 to Ex31, further comprising: a housing defining an exterior surface of the battery; and an electrolyte disposed in the housing.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising.” For example, a microfluidic device comprising a sheet having an interconnected microporous structure, a double-sided adhesive layer, and a film may consist of, or consist essentially of, the sheet, the adhesive layer and the film.

As used herein, “consisting essentially of”, as it relates to a compositions, articles, systems, apparatuses or methods, means that the compositions, articles, systems, apparatuses or methods include only the recited components or steps of the compositions, articles, systems, apparatuses or methods and, optionally, other components or steps that do not materially affect the basic and novel properties of the compositions, articles, systems, apparatuses or methods.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

1. An electrochemical cell comprising:
a cathode electrode comprising:
a cathode major surface; and
one or more cathode edges defining a perimeter of the cathode major surface; and
an anode electrode comprising:
lithium;
an anode major surface facing the cathode major surface; and
one or more anode edges defining a perimeter of the anode major surface, the one or more anode edges arranged line-to-line with the one or more cathode edges.

2. The electrochemical cell as in claim 1, wherein a height of the anode electrode is equal to or less than a height of the cathode electrode.

3. The electrochemical cell as in claim 1, wherein a width of the anode electrode is equal to or less than a width of the cathode electrode.

4. The electrochemical cell as in claim 1, wherein the anode major surface comprises an overhang portion relative to the cathode major surface of no greater than 0.5 millimeters.

5. The electrochemical cell as in claim 1, wherein the anode electrode defines a plurality of windings.

6. The electrochemical cell as in claim 1, wherein the anode electrode defines a hollow cylinder.

7. The electrochemical cell as in claim 1, further comprising a separator disposed between the cathode electrode and the anode electrode.

8. The electrochemical cell as in claim 1, further comprising:
a housing defining an exterior surface of the electrochemical cell; and
an electrolyte disposed in the housing.

9. A system comprising:
a battery comprising:
a cathode electrode comprising:
a cathode major surface; and
one or more cathode edges defining a perimeter of the cathode major surface; and
an anode electrode comprising:
lithium;
an anode major surface facing the cathode major surface; and
one or more anode edges defining a perimeter of the anode major surface, the one or more anode edges arranged line-to-line with the one or more cathode edges; and
a battery management system operatively coupled to the battery and configured to limit a charging current of the battery to a threshold charging rate of C/5.

10. The system as in claim 9, wherein the battery management system is further configured to provide an indication of the threshold charging rate to an external device.

11. The system as in claim 9, further comprising a charging apparatus operatively couplable to the battery management system and configured to charge the battery at the charging current less than or equal to the threshold charging rate.

12. The system as in claim 9, further comprising a charging apparatus operatively couplable to the battery management system and configured to:
determine the threshold charging rate; and
charge the battery using the charging current less than or equal to the threshold charging rate.

13. The system as in claim 9, wherein a height of the anode electrode is equal to or less than a height of the cathode electrode.

14. The system as in claim 9, wherein a width of the anode electrode is equal to or less than a width of the cathode electrode.

15. An implantable medical device comprising:
a housing;
a battery comprising:
a cathode electrode comprising:
a cathode major surface; and
one or more cathode edges defining a perimeter of the cathode major surface; and
an anode electrode comprising:
lithium;
an anode major surface facing the cathode major surface; and
one or more anode edges defining a perimeter of the anode major surface, the one or more anode edges arranged line-to-line with the one or more cathode edges; and
a controller disposed in the housing and operatively coupled to the battery.

16. The implantable medical device as in claim 15, wherein a height of the anode electrode is equal to or less than a height of the cathode electrode.

17. The implantable medical device as in claim 15, wherein a width of the anode electrode is equal to or less than a width of the cathode electrode.

18. The implantable medical device as in claim 15, wherein the anode major surface comprises an overhang portion relative to the cathode major surface of no greater than 0.5 millimeters.

19. The implantable medical device as in claim 15, wherein the implantable medical device further comprises a battery management system operatively coupled to the battery and configured to limit a charging current of the battery to a threshold charging rate of C/5.

20. The implantable medical device as in claim 19, wherein the battery management system is further configured to provide an indication of the threshold charging rate to an external device, wherein the implantable medical device further comprises a charging apparatus operatively couplable to the battery management system and configured to charge the battery at the charging current less than or equal to the threshold charging rate.
